(19) United States
(12) Patent Application Publication
(10) Pub. No.: US 2006/0158137 A1
(43) Pub. Date: Jul. 20, 2006

(54) Flickering control device for personal articles

(75) Inventor: Cheng-Yang Tsai, Taichung (TW)

Correspondence Address: NIKOLAI & MERSEREAU, P.A., 900 SECOND AVENUE SOUTH, SUITE 820, MINNEAPOLIS, MN, 55402, US

(73) Assignees: Cheng-Yang Tsai, Taichung (TW); Kuo-Hsun Wu, Taichung (TW); Wen-Yu Chiu, Changhua Hsien (TW)

(21) Appl. No.: 11/039,728

(22) Filed: Jan. 19, 2005

(51) Int. Cl. H05B 39/00

(52) U.S. Cl. 315/312

(57) ABSTRACT

A flickering control device for personal articles is disclosed, which is mounted in personal articles such as sneakers, handbags etc. The flickering control device has a program controller with multiple flickering mode modules built in, multiple LEDs and a switch group. The program controller and the LEDs are set in the personal articles, while the switch group is connected externally. In this way, users are able to manipulate the flickering control device conveniently.

### BACKGROUND OF THE INVENTION

1. Field of the Invention

The present invention relates to a flickering control device, particularly relates to a flickering control device embedded in personal articles and controlled exteriorly.

2. Description of Related Art

With the development of the living standards, consumers' demands for commodities are not limited in their basic functions, for example, clothes are not only for warmth but are also for decoration; shoes are not only for protection but are also for decoration. Commodities with more additional functions will be more popular in the market as people have more disposable income and leisure time.

Flickering lights for ornamentation produced by flickering control devices and LEDs (light emitting diode) are used in personal articles such as sneakers, handbags, etc. Take the sneaker for instance, the flickering control device, an oscillating switch, and batteries are equipped in a middle sole of the sneaker, the flickering control device is connected with multiple LEDs which are spread around the periphery of the sneaker. When the user is walking, the oscillating switch is on to drive the LEDs to flicker. Furthermore, the flickering lights for ornamentation can also be applied in handbags.

However, there are still some problems for the flickering control device:

1. Only one control mode: the flickering control device has to cooperate with the oscillating switch, in other words, the flickering control device operates only when the user is walking, otherwise, the LEDs will not light and flicker.

2. Limited working time: the main circuit and batteries are encapsulated in the sneaker; the batteries can not be replaced. The flickering function is terminated once the power of the batteries is exhausted.

3. Only a single operating mode: the oscillating switch has two statuses: on or off, which can only produce a single operating mode.

Therefore, the invention provides a flickering control device to mitigate or obviate the aforementioned problems.

### SUMMARY OF THE INVENTION

The main objective of the present invention is to provide a flickering control device embedded in personal articles, which has a plurality of flickering modes for ornamentation, as well as having the switch mounted externally to facilitate control.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of the flickering control device in accordance to this invention;

FIG. 2 is an exploded view of the flickering control device applied in a sneaker;

FIG. 3 is a perspective view of the flickering control device applied in the sneaker; and

FIG. 4 is a perspective view of the flickering control device applied in a handbag.

### DETAILED DESCRIPTION OF THE PREFERRED EMBODIMENT

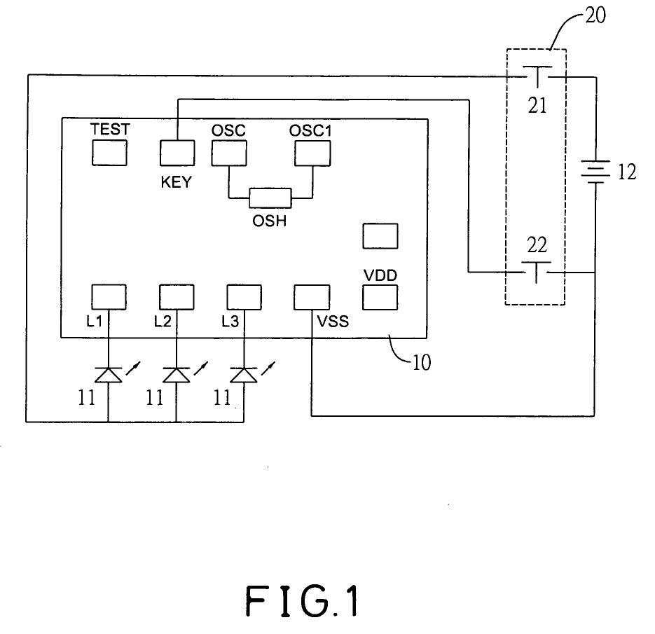

With reference to FIG. 1, the flickering control device has a program controller (10) with multiple flickering mode modules built in. Flickering modes include undulating flickering mode, single LED fade-in-fade-out mode, multiple LEDs fade-in-fade-out mode, starlight mode, all shine mode, transforming mode (transforming among the above modes) etc.

Multiple LEDs (11) are connected to output pins L1˜L3 of the program controller (10) and those LEDs (11) are of same or different colors.

Batteries (12) are mounted to provide power supply to the program controller (10) and the LEDs (11).

A switch group (20) consists of at least two switches (21), (22), wherein the first switch (21) is a power switch connected between the batteries (12) and the program controller (10); and the second switch (22) is a mode switch connected between a specific pin “KEY” from the program controller (10) and a battery cathode. Therefore, the first switch (21) is used to control the on/off status of the flickering control device, and the second switch (22) can be a slide switch or a touch switch, either of which is responsible for mode conversion.

The flickering control device is embedded in the personal articles, and transmits the light via a light layer (not numbered in FIG. 1) of the periphery of the personal article; the switch group (20) is mounted externally to facilitate being handled. No matter whether the user is walking, the flickering function can be activated by switch (21), and transformed to different modes by a switch (22).

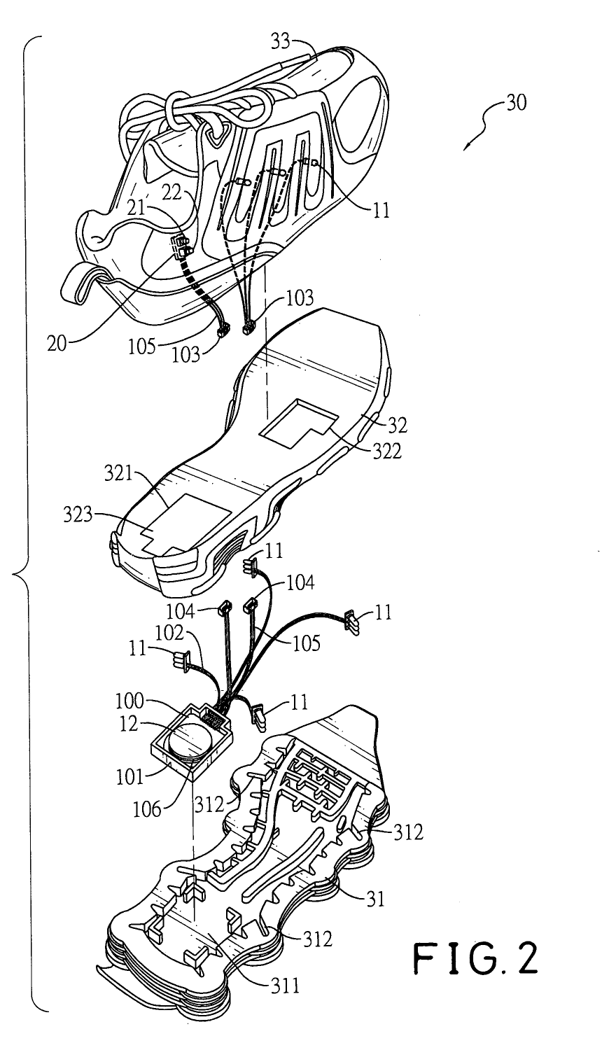

FIG. 2 shows the flickering control device of this invention applied in a sneaker (30). Abox (101) is set to accommodate a circuit board (100), and the program controller (not numbered in FIG. 2) and a battery house (106) for holding batteries (12) are built in the circuit board (100). The program controller is connected to the LEDs (11) via a conducting wire (102), or connected to LEDs via a conducting wire (105), and a male/female adapter (103), (104). The conducting wire (105) and the male/female adapter (103), (104) are also used to connect the circuit board (100) and the switch group (20).

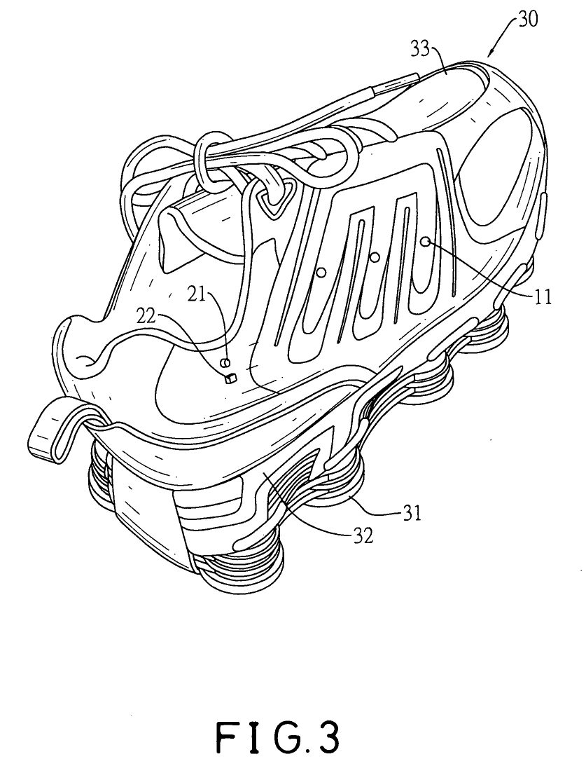

With reference to FIG. 2 and FIG. 3, the sneaker (30) consists of an outsole (31), a middle sole (32) and a vamp (33). A recess and multiple slots are defined in the outsole (31) to secure the box (101) and the multiple LEDs (11). The material for the outsole (31) is normally pervious or partly pervious to light.

The middle sole (32) covers the outsole (31) and is integrated with the outsole (31). A first hole (321) and a second hole (322) are defined in the middle sole (32). The conducting wires (102) and (105) extend through the first hole (321), wherein the former (102) is used for equipping the LEDs (11) on the vamp (33); the latter (105) is used for externally setting the switch group (20) on the vamp. The first hole (321) has a cover (323) thereon which is conceals the box (101). The middle sole (32) is integrated with the vamp (33) to define a chamber for a foot. When the sneaker is not in use and the batteries are exhausted, the cover (323) can be removed to enable replacement of the batteries (12) in the box (101).

Therefore, the vamp (33) is also equipped with at least one LED (11) connected with the circuit board (100) in the outsole (31) via the conducting wire (102), so the flickering light of the vamp can be seen. The switch group (20) is also set on the vamp externally, so that the user can control the flickering function conveniently.

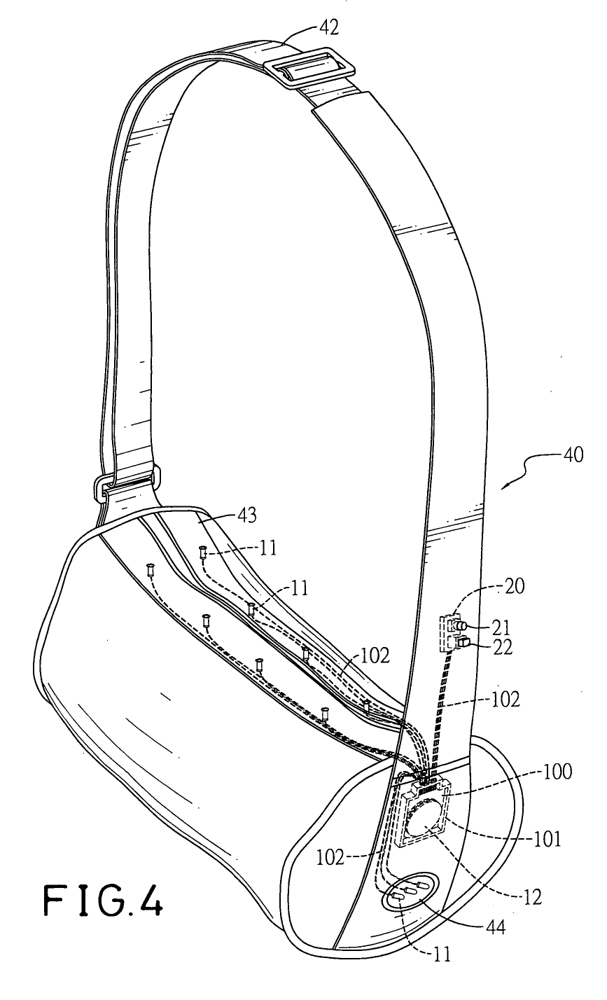

With reference to FIG. 4, another embodiment of this invention is disclosed. The flickering control device is applied in a handbag (40) consisting of a pocket (41) and a shoulder strap (42). Some parts of the shoulder strap (42) and the pocket (41) are light layers (43) that are pervious to light. Multiple LEDs (11) are mounted inside those light layers (43) and the switch group (20) is set at the shoulder strap (42) to facilitate control, especially, the light layer (43) can be formed as a logo of the manufacturer of the bag, thus the LEDs (11) are set to make the logo more eye-catching. The program controller (10) is still built in the circuit board (100), which can also be received into a box (101) in the pocket (41) or set in the light layer (43).

In addition to the sneaker and the handbag, the invention can be applied in other personal articles.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A flickering control device for personal articles, and the flickering control device comprising:
a program controller with multiple flickering mode modules built into the program controller;
multiple LEDs connected to output pins of the program controller;
batteries providing power to the program controller and the LEDs; and
a switch group comprising at least two switches which is set exterior of the personal articles;
wherein the personal articles include a sneaker comprising
an outsole having a recess and multiple slots to secure a box and the multiple LEDs, wherein the box accommodates a circuit board having the program controller and a battery house built in, and the battery house holds the batteries inside;
a middle sole covering and being integrated with the outsole and having
a first hole having a cover; and
a second hole; and
a vamp.

2. The flickering control device as claimed in claim 1, wherein
one of the switches is connected between the batteries and the program controller, for controlling an on/off status of the flickering control device, and
another one of the switches responsible for mode conversion is connected between a specific pin “KEY” and the batteries.

3. The flickering control device as claimed in claim 2, wherein the program controller is connected to the LEDs and the switch group via a conducting wire.

4. The flickering control device for personal articles as claimed in claim 2, wherein the program controller is connected to the LEDs and the switch group via the conducting wire and a male/female adapter.

5. (canceled)

6. The flickering control device as claimed in claim, wherein the LEDs and the switch group are mounted on the vamp.

7. The flickering control device for personal articles as claimed in claim 6, wherein a material for the outsole is normally pervious or partly pervious to light.

8. (canceled)
